(19) United States
(12) Patent Application Publication
(10) Pub. No.: US 2015/0310619 A1
(43) Pub. Date: Oct. 29, 2015

(54) Single-Camera Distance Ranging Method and System

(71) Applicant: ZTE CORPORATION, Shenzhen, Guangdong Province (CN)

(72) Inventor: Heng CAO, Shenzhen, Guangdong Province (CN)

(73) Assignee: ZTE Corporation, Shenzhen, Guangdong Province (CN)

(21) Appl. No.: 14/648,690

(22) PCT Filed: Jul. 31, 2013
(86) PCT No.: PCT/CN2013/080563

§ 371 Date: May 29, 2015

(30) Foreign Application Priority Data
Nov. 30, 2012 (CN) 201210504460.9

(51) Int. Cl. G06T 7/00; G01B 11/14; H04N 5/225

(52) U.S. Cl. CPC G06T 7/0071; G06T 7/0085; G06T 7/0044; H04N 5/225; G01B 11/14; G06T 2207/10016; G06T 2207/10028; G06T 2207/30244

(57) ABSTRACT

Disclosed are a method and system for single-camera distance ranging. When a mobile terminal is in camera filming mode, the outer edge of a target object is continuously recognized and tracked. A user orients the mobile terminal toward the target object and moves said terminal laterally; the mobile terminal calculates the distance between the mobile terminal and the target object according to the change in the display width of the target object on a screen or the change in the framing width on a mobile terminal screen and the lateral-shift distance of the mobile terminal. The whole ranging process is completed based on the existing mobile terminal image processing and movement perception functions, thereby making possible single-camera ranging from a mobile terminal with no requirement for additional optical component. Ranging accuracy can be further enhanced with the addition of a posture-monitoring step during the lateral movement of the mobile terminal.

### TECHNICAL FIELD

The disclosure relates to the field of mobile terminal technology, and including to a single-camera distance ranging method and system.

### BACKGROUND

Most of mobile terminals are equipped with a rear-face camera and a face camera, and the shooting and imaging process of the rear-face camera and the face camera are similar. An optical image of an object to be shot generated through a lens is projected onto the surface of an image sensor and converted to an analog electrical signal, which is then converted into a digital image signal through an Analog-Digital Converter (ABC). The digital image signal is sent to an Image Signal Processor (ISP) for processing, and finally the processed digital image signal is saved in a storage and shown on a mobile terminal screen by calling Baseband Processor (BP).

Distance ranging methods by utilizing a camera mainly include a dual-camera method and a combinatorial method of single-camera and laser head. In the dual-camera method, the images of an object to be measured are acquired by two cameras, and the distance of a spot on the object to be measured is determined according to parallax images of the spot in two cameras. In the combinatorial method of single-camera and laser head, a laser beam launched by a laser head is received and processed so as to obtain a corresponding distance. It is needed to add components when the above camera distance ranging methods are applied in a mobile terminal, for example adding a camera or a laser head, and the structure and appearance design of the mobile terminal also need to be changed.

### SUMMARY

A single-camera distance ranging method and system are provided in the disclosure, which are used for realizing single-camera ranging based on that a mobile terminal does not need to add optical components.

According to an embodiment of the disclosure, a single-camera distance ranging method, comprising: a displaying and inputting step: a camera of a mobile terminal acquiring an image which contains a target object and displaying the image on a screen, and receiving a selection of the target object by a user; a tracking step: during a translation of the mobile terminal towards the target object, recognizing and tracking the target object; a recording step: recording a translation distance of the mobile terminal and a ratio of a display width of the target object before the translation of the mobile terminal to a display width of the target object after the translation of the mobile terminal; and a calculating step: based on data recorded in the recording step, calculating a distance between the mobile terminal and the target object.

According to an embodiment of the disclosure, the method further comprises: a monitoring step: monitoring a posture during the translation of the mobile terminal towards the target object, and when a rotation of the mobile terminal is monitored, reporting that a distance ranging operation fails; when the rotation of the mobile terminal is not monitored, continuing to execute the tracking step.

According to an embodiment of the disclosure, the method further comprises: a judging step: when the rotation of the mobile terminal is monitored in the monitoring step, judging whether the rotation of the mobile terminal is valid, and when the rotation of the mobile terminal is valid, continuing to execute the tracking step; when the rotation of the mobile terminal is not valid, reporting that the distance ranging operation fails; a valid rotation comprises: for a mobile terminal with a camera being on a center position of the mobile terminal, a rotation of the mobile terminal around the center position of the mobile terminal in a plane where the mobile terminal locates; for a mobile terminal with a camera being on other position except the center position of the mobile terminal, a rotation of the mobile terminal around the center position of the mobile terminal in the plane where the mobile terminal locates, when a line from the center position of the mobile terminal to a center position of the target object is perpendicular to the plane where the mobile terminal locates.

According to an embodiment of the disclosure, in the monitoring step, the posture during the translation of the mobile terminal towards the target object is monitored by a three-axis gyro in the mobile terminal.

According to an embodiment of the disclosure, in the recording step, the translation distance of the mobile terminal is acquired by an accelerometer in the mobile terminal and the acquired translation distance of the mobile terminal is recorded.

According to an embodiment of the disclosure, a single-camera distance ranging system, located on a mobile terminal, comprising: a displaying and inputting component: configured to acquire an image which contains a target object by a camera of a mobile terminal and display the image on a screen; and receive a selection of the target object by a user; a tracking component: configured to recognize and track the target object during a translation of the mobile terminal towards the target object; a recording component: configured to record a translation distance of the mobile terminal and a ratio of a display width of the target object before the translation of the mobile terminal to a display width of the target object after the translation of the mobile terminal; and a calculating component: configured to calculate a distance between the mobile terminal and the target object based on data recorded in the recording component.

According to an embodiment of the disclosure, the system further comprises: a monitoring component: configured to monitor a posture during the translation of the mobile terminal towards the target object, and when a rotation of the mobile terminal is monitored, reporting that a distance ranging operation fails; when the rotation of the mobile terminal is not monitored, continue to call the tracking component to recognize and track the target object.

According to an embodiment of the disclosure, the system further comprises: a judging component: configured to, when the rotation of the mobile terminal is monitored by the monitoring component, judge whether the rotation of the mobile terminal is valid, and when the rotation of the mobile terminal is valid, continue to call the tracking component to recognize and track the target object; when the rotation of the mobile terminal is not valid, report that the distance ranging operation fails; a valid rotation comprises: for a mobile terminal with a camera being on a center position of the mobile terminal, a rotation of the mobile terminal around the center position of the mobile terminal in a plane where the mobile terminal locates; for a mobile terminal with a camera being on other position except the center position of the mobile terminal, a rotation of the mobile terminal around the center position of the mobile terminal in the plane where the mobile terminal locates, when a line from the center position of the mobile terminal to a center position of the target object is perpendicular to the plane where the mobile terminal locates.

According to an embodiment of the disclosure, the monitoring component is configured to monitor the posture during the translation of the mobile terminal towards the target object by a three-axis gyro in the mobile terminal.

According to an embodiment of the disclosure, the recording component is configured to acquire the translation distance of the mobile terminal by an accelerometer in the mobile terminal and record the acquired translation distance of the mobile terminal.

By utilizing the above technical solution, the embodiments of the disclosure can bring at least the following advantages: in the single-camera distance ranging method and system described in embodiments of the disclosure, when the mobile terminal is in camera photograph mode, the outer edge of the target object is continuously recognized and tracked; the mobile terminal is translated toward the target object by the user. The mobile terminal calculates the distance between the mobile terminal and the target object according to the change in the display width of the target object on a screen or the change in the framing width on the screen of the mobile terminal and the translation distance of the mobile terminal. The whole distance ranging process is completed based on the existing mobile terminal image processing and movement perception functions, thereby making possible single-camera distance ranging by a mobile terminal with no requirement for additional optical component. The accuracy of the distance ranging can be further enhanced with the added step for monitoring the posture during the translation of the mobile terminal towards the target object.

### DESCRIPTION OF THE DRAWINGS

FIG. 1 is a flowchart of a single-camera distance ranging method of a first example embodiment of the disclosure;

FIG. 2 is a flowchart of a single-camera distance ranging method of a second example embodiment of the disclosure;

FIG. 3 is a flowchart of a single-camera distance ranging method of a third example embodiment of the disclosure;

FIG. 4 is a composition diagram of a single-camera distance ranging system of a fourth example embodiment of the disclosure;

FIG. 5 is a composition diagram of a single-camera distance ranging system of a fifth example embodiment of the disclosure;

FIG. 6 is a composition diagram of a single-camera distance ranging system of a sixth example embodiment of the disclosure;

FIG. 7 is a diagram of changes in related distance and ratio before and after a camera of a mobile phone translates towards a target object of an application example of the disclosure;

FIGS. 8 (a), (b) are respectively diagrams of changes in size and related ratio of a target object from a perspective of a screen before and after a camera of a camera translates towards the target object in an application example of the disclosure;

FIG. 9 is a flowchart of a single-camera distance ranging method of an application example of the disclosure;

FIG. 10 is a composition diagram of a single-camera distance ranging system of an application example of the disclosure.

### DESCRIPTION OF EMBODIMENTS

In order to further describe the technical feature and effect used in the disclosure for reaching a predetermined purpose, the embodiment of the disclosure will be illustrated in detail in combination with the drawings and the example embodiments below.

The current mobile terminals are equipped with components that can locate own orientation accurately, such as three-axis gyro, the largest role of which is to measure angular velocities in X-Y-Z axis of three-dimensional space, thereby determining motion state of an object.

The mobile terminals are further equipped with components that can measure acceleration of a moving object accurately, such as accelerometer. When the accelerometer is in accelerated motion, a mass block inside is acted by the inertance and therefore moves in an opposite direction. The displacement of the mass block is limited by a spring and a damper, so that the outside acceleration can be measured by an output voltage. In addition, the displacement is just obtained by a double integral on the acceleration, and therefore the measurement of displacement can be achieved by using an acceleration sensor.

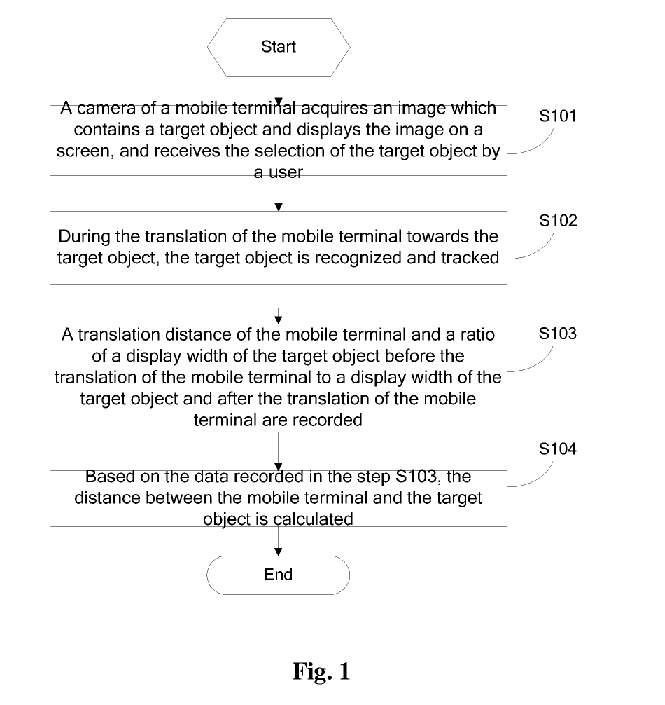

A single-camera distance ranging method in a first example embodiment of the disclosure is shown in FIG. 1, and the method comprises the following steps:

Step S101, a camera of a mobile terminal acquires an image which contains a target object and displays the image on a screen, and receives the selection of the target object by a user.

Optionally, for a screen with touch functionality, the user can input a contour of the target object by means of clicking or drawing a line. For a mobile terminal with an ordinary screen, the user can also input the contour of the target object by keys on a keyboard. Alternatively, for a mobile terminal that can automatically recognize a target object on the screen, when the approximate region where the target object locates is clicked by the user, the mobile terminal can recognize the target object within the region or near the region.

Step S102, during the translation of the mobile terminal towards the target object, the target object is recognized and tracked.

Optionally, the mobile terminal can recognize and track the target object input in step S101 according to a related algorithm in the existing image processing technologies. For example: when the difference in brightness or colour between the target object and the background of the target object is greater, image edge extraction algorithms can be adopted to recognize and track the target object. Wherein the image edge extraction algorithms can comprise at least one of the following: an adaptive threshold multi-scale edge extraction algorithm based on B-spline wavelets, a multi-scale discrete Canny edge extraction algorithm with combination of embedded confidence, a new edge contour extraction model-quantum statistical deformable model image edge tracking algorithm, an image tracking algorithm based on particle filter, a multi-information fusion particle filter tracking algorithm of the algorithm for melding a structural information and scale invariant feature transformation, an improved hausdorff video target tracking algorithm and so on.

Step S103, a translation distance of the mobile terminal and a ratio of a display width of the target object before the translation of the mobile terminal to a display width of the target object after the translation of the mobile terminal are recorded.

Optionally, the recorded ratio of the display width of the target object before the translation of the mobile terminal towards the target object to the display width of the target object after the translation of the mobile terminal towards the target object can be replaced with a ratio of a screen framing width of the target object before the translation of the mobile terminal towards the target object to a screen framing width of the target object after the translation of the mobile terminal towards the target object. During the translation of the mobile terminal, the target object is always within the framing scope of the mobile terminal screen. In addition, a translation distance of the mobile terminal is acquired by the accelerometer in the mobile terminal and the acquired translation distance of the mobile terminal is recorded.

Step S104, based on the data recorded in the step S103, the distance between the mobile terminal and the target object is calculated.

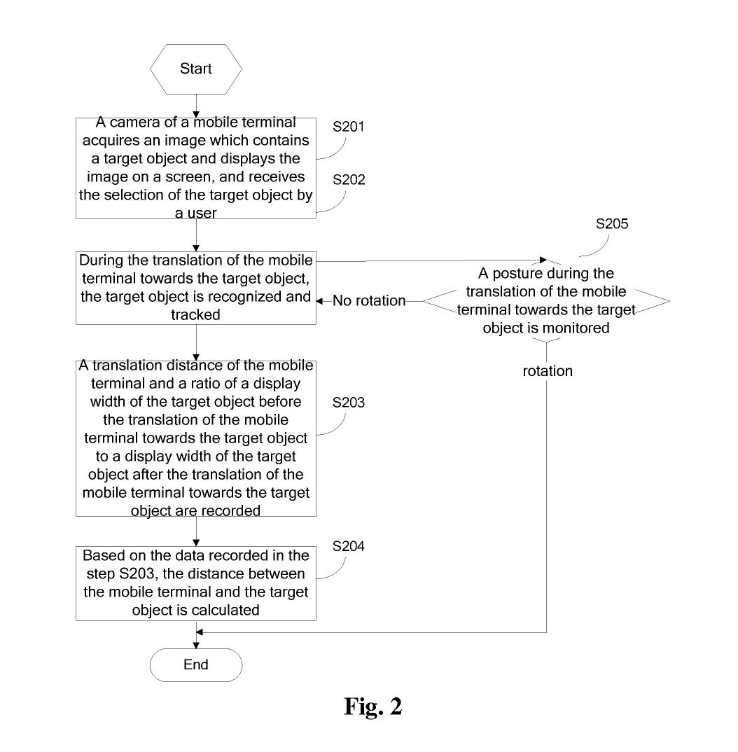

A single-camera distance ranging method in a second example embodiment of the disclosure is shown in FIG. 2, and the steps S201, S203, S204 of the method described in the second example embodiment are respectively the same to the steps S101, S103, S104 of the method described in the first example embodiment. The difference between the second example embodiment of the present and the first example embodiment of the disclosure is that, while the step S202 is executed in the second example embodiment, a step S205 of monitoring the posture during the translation of the mobile terminal towards the target object is further added. The translation described in the embodiment of the disclosure is mainly compared to the rotation, and when there is no rotation during the translation of the mobile terminal towards the target object, the accuracy of the distance ranging results can be ensured. For example, the following operations can be executed:

Step S205, the posture during translation of the mobile terminal towards the target object is monitored, and when a rotation of the mobile terminal is monitored, it is reported that a distance ranging operation fails, and the flow is ended; when the rotation of the mobile terminal is not monitored, the step S202 is continued to be executed.

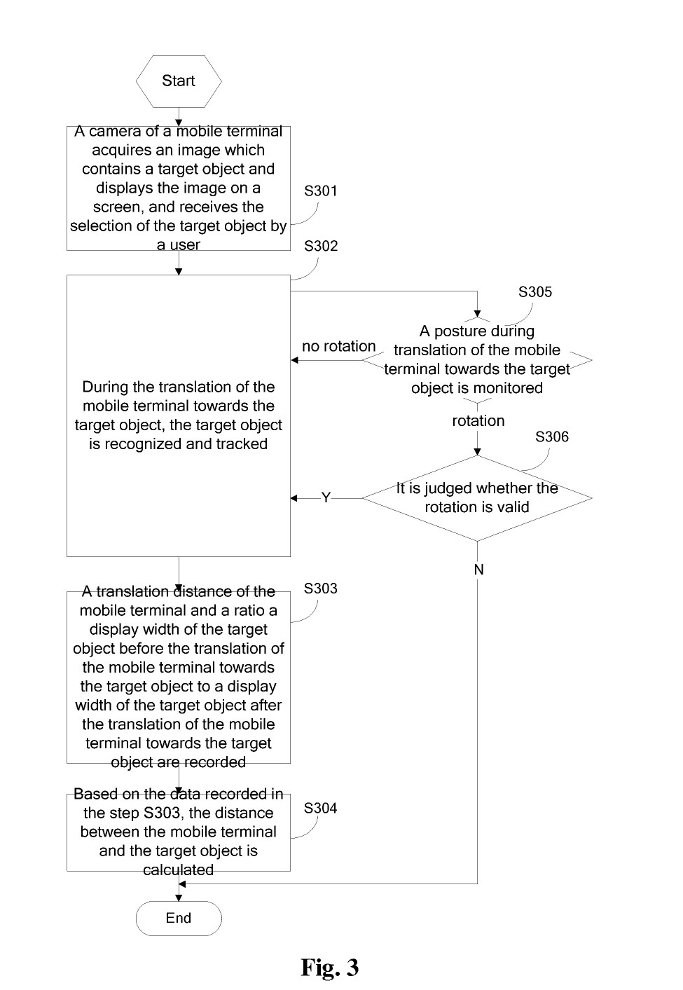

A single-camera distance ranging method in the third example embodiment of the disclosure is shown in FIG. 3, and the steps S301, S303, S304 of the method described in the third example embodiment are respectively the same to the steps S101, S103, S104 of the method described in the first example embodiment. The difference between the third example embodiment of the disclosure and the first example embodiment of the disclosure is that, while the step S302 is executed in the third example embodiment, a step S305 of monitoring the posture during the translation of the mobile terminal towards the target object and a judgement step S306 are further added. For example, the following operations can be executed:

Step S305, the posture during the translation of the mobile terminal towards the target object monitored, and when the rotation of the mobile terminal is monitored, the step S306 is executed; when the rotation of the mobile terminal is not monitored, step S302 is continued to be executed.

Optionally, the posture during the translation of the mobile terminal towards the target object can be monitored by a three-axis gyro in the mobile terminal. When the mobile terminal rotates, the three-axis gyro reports the data about orientation and angular velocity during the rotation and so on, and the mobile terminal can further judge whether the rotation is permitted according to these data, namely executing step S306. In a practical application, when a mobile terminal hold by the user is to perform the distance ranging operation, it is easy to jitter the mobile terminal so as to cause a slight rotation of the mobile terminal, but the rotation can be permitted if the rotation does not influences result of the distance ranging operation.

Step S306, it is judged whether the rotation is valid, and when the rotation of the mobile terminal is valid, the step S302 is continued to be executed; when the rotation of the mobile terminal is not valid, it is reported that the distance ranging operation fails and the flow is ended.

Optionally, the valid rotation comprises: for a mobile terminal with a camera being on a center position of the mobile terminal, a rotation of the mobile terminal around the center position of the mobile terminal in a plane where the mobile terminal locates; and for a mobile terminal with a camera being on other position except the center position of the mobile terminal, a rotation of the mobile terminal around the center position of the mobile terminal in the plane where the mobile terminal locates, when a line from the center position of the mobile terminal to the center position of the target object is perpendicular to the plane where the mobile terminal locates.

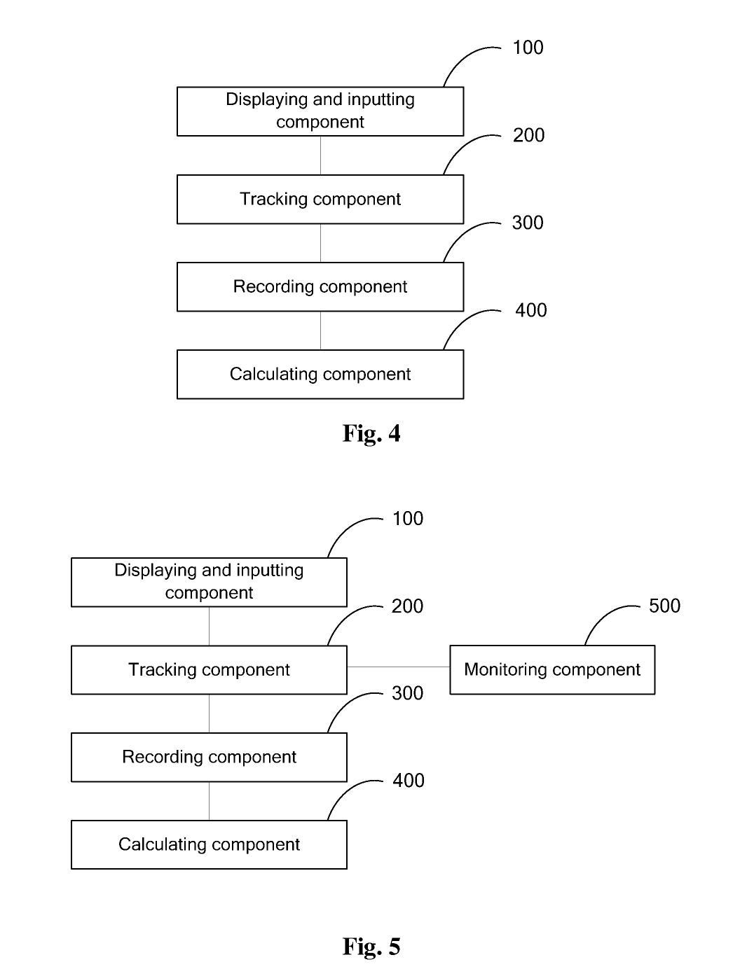

A single-camera distance ranging system in a fourth example embodiment of the disclosure is located on a mobile terminal, and as shown in FIG. 4 the system comprises:

A displaying and inputting component 100: configured to acquire an image which contains a target object by a camera of a mobile terminal and display the image on a screen; and receive the selection of the target object by a user.

Optionally, for a screen with touch functionality, the displaying and inputting component 100 can receive a contour of the target object input by means of clicking or drawing a line on a screen by the user. For a mobile terminal with an ordinary screen, the displaying and inputting component 100 can also receive the contour of the target object input by means of pressing keys on a keyboard by the user. Alternatively, for a mobile terminal that can automatically recognize a target object on the screen, when the approximate region where the target object locates is clicked by the user by the displaying and inputting component 100, the mobile terminal can recognize the target object within the region or near the region.

A tracking component 200: configured to recognize and track the target object during the translation of the mobile terminal towards the target object.

Optionally, the tracking component 200 can recognize and track the target object input by the displaying and inputting component 100 according to a related algorithm in current image processing technologies. For example: when the distance in brightness or colour between the target object and the background of the target object is greater, image edge extraction algorithms can be adopted to recognize and track the target object. Wherein the image edge extraction algorithms can comprise at least one of the following: an adaptive threshold multi-scale edge extraction algorithm based on b-spline wavelets, a multi-scale discrete Canny edge extraction algorithm with combination of embedded confidence, a new edge contour extraction model-quantum statistical deformable model image edge tracking algorithm, an image tracking algorithm based on particle filter, a multi-information fusion particle filter tracking algorithm of the algorithm for melding a structural information and scale invariant feature transformation, an improved hausdorff video target tracking algorithm and so on.

A recording component 300: configured to record a translation distance of the mobile terminal and a ratio of a display width of the target object before the translation of the mobile terminal towards the target object to a display width of the target object after the translation of the mobile terminal towards the target object are recorded.

Optionally, the ratio recorded by the recording component 300 the display width of the target object before the translation of the mobile terminal towards the target object to the display width of the target object after the translation of the mobile terminal towards the target object is replaced with a ratio of a screen framing width of the target object before the translation of the mobile terminal towards the target object to a screen framing width of the target object after the translation of the mobile terminal towards the target object. During the translation of the mobile terminal, the target object is always is within the framing scope of the mobile terminal screen. In addition, the recording component 300 can acquire the translation distance of the mobile terminal by the accelerometer equipped on the mobile terminal and record the acquired translation distance of the mobile terminal.

A calculating component 400: configured to calculate the distance between the mobile terminal and the target object based on data recorded in the recording component.

A single-camera distance ranging system in the fifth example embodiment of the disclosure is shown in FIG. 5, and a displaying and inputting component 100, a recording component 300, a calculating component 400 of the system described in the fifth example embodiment are the same to the corresponding components in the fourth example embodiment. The difference between the fifth example embodiment of the disclosure and the fourth example embodiment of the disclosure is that, a monitoring component 500 is added, wherein the monitoring component 500 is configured to, during the executing process of the tracking component 200, monitor the posture during the translation of the mobile terminal towards the target object so as to ensure the accuracy of the distance ranging results. For example:

A monitoring component 500: configured to monitor the posture during the translation of the mobile terminal towards the target object, and when a rotation of the mobile terminal is monitored, report that a distance ranging operation fails; when the rotation of the mobile terminal is not monitored, continue to call the tracking component 200 to recognize and track the target object.

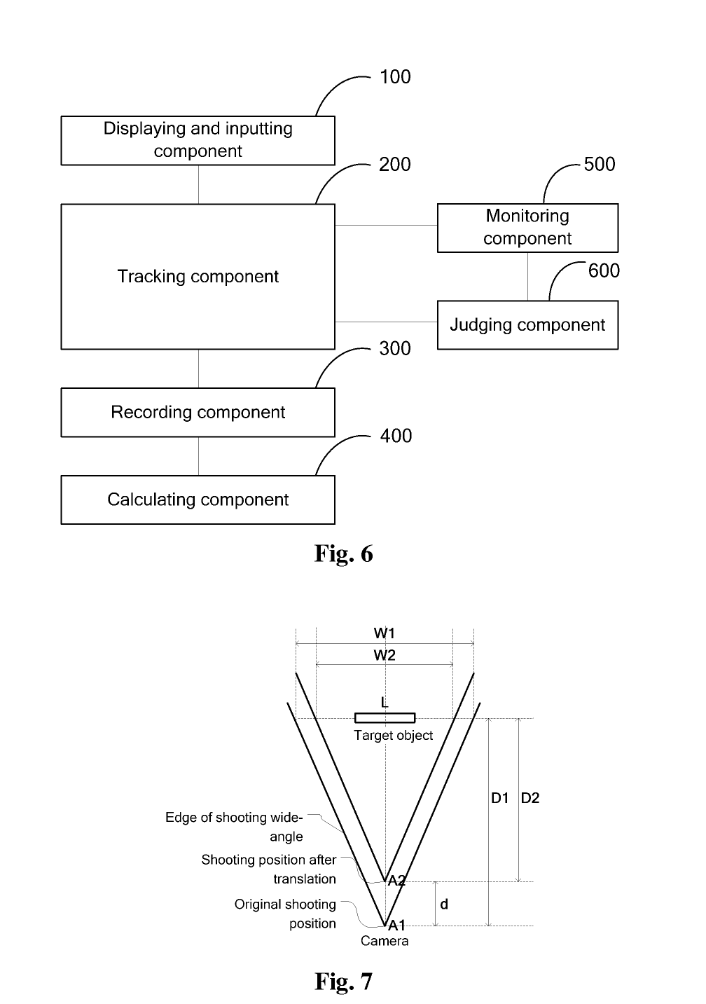

A single-camera distance ranging system in the sixth example embodiment of the disclosure is shown in FIG. 6, and a displaying and inputting component 100, a recording component 300, a calculating component 400 of the system described in the sixth example embodiment are the same to the corresponding components in the fourth example embodiment. The difference between the sixth example embodiment of the disclosure and the fourth example embodiment of the disclosure is that, a monitoring component 500 and a judging component 600 are added in the sixth example embodiment of the disclosure, wherein the monitoring component 500 is configured to, during the executing process of the tracking component 200, monitor a posture during the translation of the mobile terminal towards the target object, and the judging component 600 is configured to judge. For example:

A monitoring component 500: configured to monitor the posture during translation of the mobile terminal towards the target object, and when the rotation of the mobile terminal is monitored, call the judging component 600; when the rotation of the mobile terminal is not monitored, continue to call the tracking component 200 to recognize and track the target object.

Optionally, the monitoring component 500 can monitor the posture during the translation of the mobile terminal towards the target object by a three-axis gyro in the mobile terminal. When the mobile terminal rotates, the three-axis gyro reports the date about orientation and angular velocity during the rotation and so on, and the judging component 600 can further judge whether the rotation is permitted according to these data. In a practical application, when a mobile terminal hold by the user is to perform the distance ranging operation, it is easy to jitter the mobile terminal so as to cause a slight rotation of the mobile terminal, but the rotation can be permitted if the rotation does not influences the result of the distance ranging operation.

A judging component 600: configured to judge whether the rotation is valid, and when the rotation of the mobile terminal is valid, continue to call the tracking component 200 to recognize and track the target object; when the rotation of the mobile terminal is not valid, report that the distance ranging operation fails.

Optionally, the valid rotation comprises: for a mobile terminal with a camera being on a center position of the mobile terminal, a rotation of the mobile terminal around the center position of the mobile terminal in a plane where the mobile terminal locates; and for a mobile terminal with a camera being on other position except the center position of the mobile terminal, a rotation of the mobile terminal around the center position of the mobile terminal in the plane where the mobile terminal locates, when a line from the center position of the mobile terminal to the center position of the target object is perpendicular to the plane where the mobile terminal locates.

In the following, based on the above embodiments, an application example of utilizing a single-camera to perform distance ranging technical solution in a mobile phone is introduced in combination with the drawings 7, 8, 9 and 10.

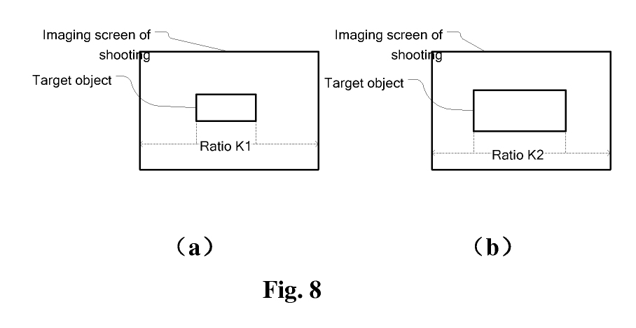

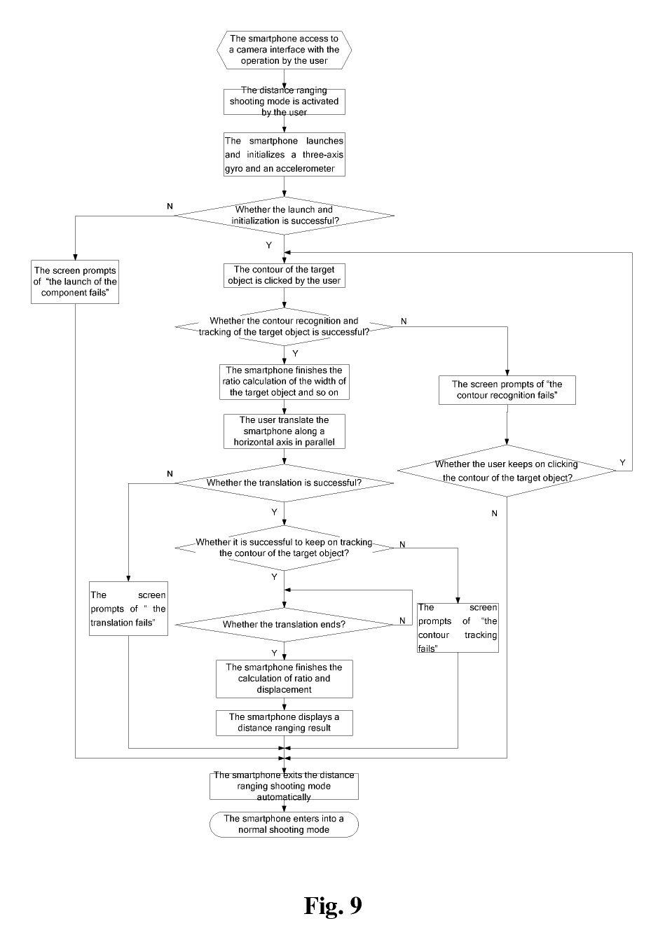

FIG. 7 is a diagram of changes in related distance and ratio before and after a camera of a mobile phone translates towards a target object, and FIGS. 8 (a), (b) are respectively diagrams of changes in size and related ratio of a target object from a perspective of a screen before and after a camera of a mobile terminal translates towards the target object.

It can be seen from FIG. 7, the camera translates horizontally from an original position A1 to a position A2, so that a distance between the camera and the target object changes from D1 to D2, thereby generating a translation distance d=D1−D2, but the width L of the target object remains unchanged, and the framing width of the target object on the screen via the camera changes from W1 to W2, wherein D1 or D2 is just the distance to be calculated between the target object and the camera. Take the calculation for D1 as an example below.

Firstly, in conjunction with FIG. 7, a ratio of a width of the target object on the screen to a framing width of the target object before and after the camera is translated will change, namely

$$K 1 = \frac{L}{W 1} , \\ K 2 = \frac{L}{W 2} .$$

In accordance with the change in ratio shown in FIG. 7, it can be obtained that:

$$\frac{D 1}{D 2 } = \frac{W 1}{W 2} ,$$

and since

$$K 1 = \frac{L}{W 1} , \\ K 2 = \frac{L}{W 2} ,$$

then

$$\frac{D 1}{D 2 } = \frac{K 1}{K 2} .$$

Furthermore, because

$$\frac{D 1}{D 1 - D 2 } = \frac{K 1}{K 1 - K 2} ,$$

and d=D1−D2, then it can be obtained that:

$$\frac{D 1}{d } = \frac{K 1}{K 1 - K 2} ,$$

namely

$$D 1 = \frac{K 1}{K 1 - K 2} \times d ,$$

that is to say that D1 can be calculated when the ratio of K1 to K2 is only known.

In conclusion, from a physical principle perspective, when the distance of the translation of the camera towards the target object is d, the ratios of the widths of the target object on the screen to the framing widths of the target object are K1, K2 respectively before and after the translation of the camera, and then the distance D1 from the camera to the target object can be obtained by a formula

$$D 1 = \frac{K 1}{K 1 - K 2} \times d .$$

In practical operation, in conjunction with FIGS. 8 (a), (b), the ratio of the display width of the target object to a screen width will also change before and after translation of the camera, and the display width of the target object changes from L1 to L2, but the screen width W of the mobile phone does not change. The above ratios K1, K2 can also be transformed to:

$$K 1 = \frac{L 1}{W} , \\ K 2 = \frac{L 2}{W} ,$$

while using

$$D 1 = \frac{K 1}{K 1 - K 2} \times d ,$$

D1 can be calculated. Because the camera is located on the mobile terminal, for the target object, the distance from the camera to the target object is just the distance from the mobile terminal to the target object.

Below, an implementation flow of an application example embodiment of the disclosure in combination with FIG. 9 is further described.

A user has a smartphone in hand, and the smartphone is equipped with a 4.5 inch In-Plane Switching (IPS) capacitive touch screen with a High Definition (HD) resolution (1280×720) and 8 megapixel/1.3 megapixel rear-face/face camera, and is equipped with a three-axis gyro and an accelerometer. Now, the user hopes to know an approximate linear distance from a sofa where he is sitting to a turned-on television directly in front of the sofa.

Firstly the smartphone access to a camera interface with the operation by the user, then use the 8 megapixel camera to take pictures, and selects “distance ranging shooting mode” in a function menu of the camera and enters into the “distance ranging shooting mode”. At the same time, an image captured by the camera is still shown in real time on the smartphone screen.

After the distance ranging shooting mode is activated, the smartphone will launch and initialize the three-axis gyro and accelerometer, thereby perceiving the current posture and movement of the smartphone. When the three-axis gyro and accelerometer do not work properly during the launch or initialization, a tip of “posture or motion sensor fails to launch” appears on the smartphone screen, thereby exiting the distance ranging shooting mode and entering a normal shooting mode.

The smartphone screen firstly prompts of clicking a contour of a target object to be measured on the captured image. Then the user clicks a contour of the television screen on the smartphone screen and confirms to finish the clicking Because there is a greater difference in brightness between the television screen and a television border as well as a television background wall, it is easy for the smartphone to recognize and track the contour of the television screen by calculating the image displayed on the screen. After recognizing and tracking the contour of the television screen, the smartphone will prompt for finishing the contour tracking on the screen. At the same time, the smartphone calculates a ratio of a display width of the contour on the screen to a width of the smartphone screen. When the smartphone finds that the contour of the target object clicked by the user can not be recognized and tracked subsequently, a tip of “the contour recognition fails” will then appear on the screen, so as to prompt the user to exit the distance ranging shooting mode or click the contour of the target object again.

Then, the smartphone screen prompts the user to translate the smartphone to the target object, and at the same time the three-axis gyro is used to monitor the posture of the smartphone, thereby ensuring that the user translates the smartphone along a horizontal axis between the smartphone and the target object and towards the target object in parallel. Since both the smartphone and the target object are perpendicular to a horizontal plane, the horizontal axis between the smartphone and the target object is just a line between the center position of the smartphone and the center position of the target object. When the smartphone detects that the user does not translate the smartphone along the horizontal axis in parallel, then a tip of “the shooting for distance ranging fails” appears on the screen, and it prompts to restart the distance ranging shooting mode.

When the user translates the smartphone, the smartphone will also keep tracking the contour of the target object, and when the contour tracking fails, then a tip of “the contour tracking for the target object fails” appears on the screen and then the smartphone exits the distance ranging shooting mode.

When the user translates the smartphone, the smartphone will perform a quadratic integral on the acceleration data of the smartphone acquired by the accelerometer, so as to obtain a translation distance of the smartphone, and at the same time the smartphone will also track the change of contour of the television screen.

After the user translates the smartphone towards the television screen along the horizontal axis for a short distance, he stops. When the accelerometer perceives the stop state of the smartphone, a tip of “the distance ranging calculation operation is executing” appears on the smartphone screen, and at the same time the smartphone will calculate a ratio of the display width of contour of the television screen on the screen to the width of the smartphone screen at the current state.

Finally, according to the ratios of the display width of contour of the television screen on the screen to the width of the smartphone screen before and after the translation and the calculated translation distance of the smartphone, the smartphone will obtain a distance between the smartphone and the television screen before the translation, and at the same time, the distance between the smartphone and the television screen after the translation can be also obtained. During the calculation, a tip of “the distance ranging calculation is executing” keeps appearing on the smartphone screen, but after calculation, a tip of “the distance ranging calculation have done” appears on the screen, and the calculated result of the distance from the original position of the smartphone to the television screen or from the current position to the television screen is shown. After the calculation result is displayed for 3 seconds, the smartphone exits the distance ranging shooting mode automatically, and enters into the normal shooting mode.

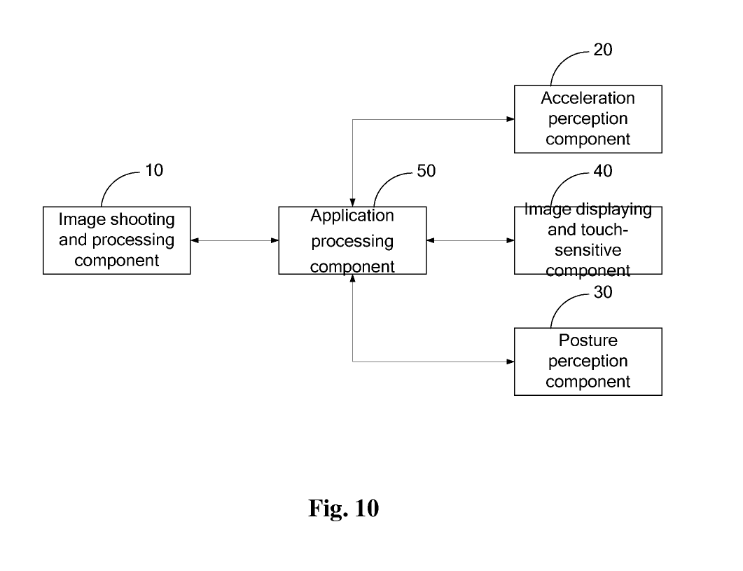

Below, an implementation system of an application example embodiment of the disclosure in combination with FIG. 10 is further described:

A. An image shooting and processing component 10, namely lens and eyeglass of a camera, image sensor, digital-to-analog converter, digital image signal processor (ISP) and related mechanisms and so on, which is a component used to convert an image of a target object into a digital image signal;

B. An acceleration perception component 20, namely an accelerometer of a smartphone and the mechanisms of the accelerometer, digital-to-analog converter and so on;

C. A posture perception component 30, namely three-axis gyro of the smartphone and the mechanisms of the three-axis gyro and so on;

D. An image displaying and touch-sensitive component 40, namely display screen or touch screen of the smartphone, and the digital-to-analog converter of the display screen or touch screen and so on;

E. An application processing component 50, namely an application processor chip of the smartphone, which can process a digital image signal, an acceleration perception signal, a posture perception signal and so on, thereby completing contour recognition and tracking of an measured object, posture monitoring and displacement calculation and so on, and can output the prompt for a user and process touch-control operation of a user and so on by the image displaying and touch-sensitive component 40.

The application processing component 50 is a core component of the system described in the application example embodiment, which can control the image shooting and the processing component 10, the acceleration perception component 20, the posture perception component 30 and the image displaying and touch-sensitive component 40, and receive and process signals from the above four components.

The displaying and inputting component 40 can acquire an image which contains a target object through cameras of the mobile terminal and display the image on the screen, and receive the input of contour of the target object by a user. The interaction between the application processing component 50 and the image shooting and processing component 10 can realize functions of recognition and tracking of the target object and obtain the ratio of the display width of the target object before the translation of the mobile terminal to the display width of the target object after the translation of the mobile terminal; the interaction between the application processing component 50 and the acceleration perception component 20 can realize a function of recording the translation distance of the mobile terminal; the posture perception component 30 can realize a function of monitoring the posture during the translation of the mobile terminal towards the target object; the application processing component 50 can further process data reported by the posture perception component 30 so as to realize a function of judging whether the rotation of the mobile terminal is valid; finally, the application processing component 50 calculates the distance between the mobile terminal and the target object based on the recorded data.

The application processing component 50 can integrate with a baseband processor chip of a smartphone, so that the baseband processor chip of the smartphone also has related functions of the application processing component 50.

In a single-camera distance ranging method and system of the embodiment of the disclosure, when the mobile terminal is in the camera photograph mode, the outer edge of the target object is continuously recognized and tracked. The mobile terminal is translated toward the target object by the user. The mobile terminal calculates the distance between the mobile terminal and the target object according to the change in the display width of the target object on a screen or the change in the framing width on the screen of the mobile terminal, and the translation distance of the mobile terminal. The whole distance ranging process is completed based on the existing mobile terminal image processing and movement perception functions, thereby making possible single-camera distance ranging by a mobile terminal with no requirement for additional optical component. In addition, the accuracy of the distance ranging can be further ensured with the added step for monitoring the posture during the translation of the mobile terminal towards the target object.

Through the description of embodiments, the technical solutions and effect used in the disclosure for reaching the predetermined purpose should be understood more deeply and specifically. However the attached figures are used only for providing references and illustration, and not for limiting the disclosure.

What is claimed is:

1. A single-camera distance ranging method, comprising:
a displaying and inputting step: a camera of a mobile terminal acquiring an image which contains a target object and displaying the image on a screen, and receiving a selection of the target object by a user;
a tracking step: during a translation of the mobile terminal towards the target object, recognizing and tracking the target object;
a recording step: recording a translation distance of the mobile terminal and a ratio of a display width of the target object before the translation of the mobile terminal to a display width of the target object after the translation of the mobile terminal; and
a calculating step: based on data recorded in the recording step, calculating a distance between the mobile terminal and the target object.

2. The method according to claim 1, wherein the method further comprises:
a monitoring step: monitoring a posture during the translation of the mobile terminal towards the target object, and when a rotation of the mobile terminal is monitored, reporting that a distance ranging operation fails; when the rotation of the mobile terminal is not monitored, continuing to execute the tracking step.

3. The method according to claim 2, wherein the method further comprises:
a judging step: when the rotation of the mobile terminal is monitored in the monitoring step, judging whether the rotation of the mobile terminal is valid, and when the rotation of the mobile terminal is valid, continuing to execute the tracking step; when the rotation of the mobile terminal is not valid, reporting that the distance ranging operation fails;
a valid rotation comprises: for a mobile terminal with a camera being on a center position of the mobile terminal, a rotation of the mobile terminal around the center position of the mobile terminal in a plane where the mobile terminal locates; for a mobile terminal with a camera being on other position except the center position of the mobile terminal, a rotation of the mobile terminal around the center position of the mobile terminal in the plane where the mobile terminal locates, when a line from the center position of the mobile terminal to a center position of the target object is perpendicular to the plane where the mobile terminal locates.

4. The method according to claim 2, wherein in the monitoring step, the posture during the translation of the mobile terminal towards the target object is monitored by a three-axis gyro in the mobile terminal.

5. The method according to claim 1, wherein in the recording step, the translation distance of the mobile terminal is acquired by an accelerometer in the mobile terminal and the acquired translation distance of the mobile terminal is recorded.

6. A single-camera distance ranging system, located on a mobile terminal, comprising:
a displaying and inputting component: configured to acquire an image which contains a target object by a camera of a mobile terminal and display the image on a screen; and receive a selection of the target object by a user;
a tracking component: configured to recognize and track the target object during a translation of the mobile terminal towards the target object;
a recording component: configured to record a translation distance of the mobile terminal and a ratio of a display width of the target object before the translation of the mobile terminal to a display width of the target object after the translation of the mobile terminal; and
a calculating component: configured to calculate a distance between the mobile terminal and the target object based on data recorded in the recording component.

7. The system according to claim 6, wherein the system further comprises:
a monitoring component: configured to monitor a posture during the translation of the mobile terminal towards the target object, and when a rotation of the mobile terminal is monitored, reporting that a distance ranging operation fails; when the rotation of the mobile terminal is not monitored, continue to call the tracking component to recognize and track the target object.

8. The system according to claim 7, wherein the system further comprises:
a judging component: configured to, when the rotation of the mobile terminal is monitored by the monitoring component, judge whether the rotation of the mobile terminal is valid, and when the rotation of the mobile terminal is valid, continue to call the tracking component to recognize and track the target object; when the rotation of the mobile terminal is not valid, report that the distance ranging operation fails;
a valid rotation comprises: for a mobile terminal with a camera being on a center position of the mobile terminal, a rotation of the mobile terminal around the center position of the mobile terminal in a plane where the mobile terminal locates; for a mobile terminal with a camera being on other position except the center position of the mobile terminal, a rotation of the mobile terminal around the center position of the mobile terminal in the plane where the mobile terminal locates, when a line from the center position of the mobile terminal to a center position of the target object is perpendicular to the plane where the mobile terminal locates.

9. The system according to claim 7, wherein the monitoring component is configured to monitor the posture during the translation of the mobile terminal towards the target object by a three-axis gyro in the mobile terminal.

10. The system according to claim 6, wherein the recording component is configured to acquire the translation distance of the mobile terminal by an accelerometer in the mobile terminal and record the acquired translation distance of the mobile terminal.
